(19) United States
(12) Patent Application Publication
(10) Pub. No.: US 2011/0319435 A1
(43) Pub. Date: Dec. 29, 2011

(54) FUNGICIDE MIXTURES

(75) Inventors: Frank Saalfeld, Kurten-Duerscheid (DE); Johannes Gareiss, Koln (DE)

(73) Assignee: LANXESS DISTRIBUTION GMBH, Langenfeld (DE)

(21) Appl. No.: 13/057,027

(22) PCT Filed: Aug. 4, 2009
(86) PCT No.: PCT/EP2009/060108

§ 371 Date: Sep. 12, 2011

(30) Foreign Application Priority Data
Aug. 6, 2008 (EP) 08014062.7

(51) Int. Cl. A01N 43/54; A01P 3/00

(52) U.S. Cl. 514/266.23

(57) ABSTRACT

The invention relates to a method for combating fungi and spores and suitable means therefor, and to the use thereof.

The invention relates to a method of controlling fungi and spores such as, in particular, fungi of the family Venturiaceae and their conidia, and to compositions suitable for this purpose and their use.

Crop plant diseases triggered by pathogenic fungi have since the beginning of agriculture constituted a serious problem owing to their effects, which reach from a reduced quality of the plant products, contamination of the latter with toxins up to complete yield loss. Until a few decades ago, fungi were almost exclusively controlled with nonselective inorganic contact-acting fungicides such as, for example, Bordeaux mixture and wettable sulfur. Nowadays, organic contact-acting fungicides with good activity are also widely used. The disadvantage of all contact-acting fungicides is the fact that fungi can only be controlled during the first phases of the interaction with the plant. During these phases, the fungal spores first attach themselves to the plant surface, and germinate, and, finally, the fungus penetrates the plant. Once the fungus has penetrated the plant tissue, control with contact-acting fungicides is no longer possible. A further disadvantage is that contact-acting fungicides are usually rapidly washed off from the plant, for example by precipitation, which makes frequent repetitions of the application necessary. The fact that they can be washed off, in conjunction with frequent application, however, causes a comparatively high environmental toxicity of the contact-acting fungicides.

Organic, specifically acting fungicides have been developed in recent decades in order to overcome these disadvantages. In this context, one must distinguish between systemic, locally-systemic and translaminarly-wetting fungicides. It is a shared feature of all these types of fungicides that they penetrate at least into the plant surface, from where they are more or less distributed within the plant (see also definition hereinbelow). As a consequence, leaching only takes place to a minor degree, or not at all, and the fungi can also be controlled after they have penetrated the plant tissue.

However, the disadvantage of these fungicides is that, when they are used repeatedly, individual fungal populations can rapidly become dominant under the selection pressure of the respective fungicide and, as a consequence, further treatments with the same fungicide at the same location are ineffective due to the development of resistance. This is why there is a need to carry out a complicated spray sequence in the course of the year using different fungicides, which is complicated and costly.

The abovementioned disadvantages of contact-acting fungicides, i.e. the fact that they can typically be washed off to a large extent, in conjunction with only a short-term activity and increased environmental toxicity, and the disadvantages of specifically-acting fungicides, which, when used repeatedly, can generate resistances, make it desirable to provide novel fungicidal compositions which overcome the abovementioned disadvantages.

Subjects of the invention are, therefore, fungicidal compositions comprising, as components,
at least one fungicide
formate
at least one substance which, as a one-molar solution in water or calculated as a one-molar solution in water or an aqueous comparative scale has a pH of 5.0 or less under standard conditions. Such substances are hereinbelow referred to as “acidic substances” for the sake of simplicity.

Suitable fungicides are preferably those fungicides which are selected from the group of the systemic, locally-systemic or translaminarly-wetting organic fungicides or the nonsystemic fungicides.

In the context of the invention, the term nonsystemic fungicide stands for a fungicidally active substance which is taken up into the plant either not at all or to a negligible extent only, and which, instead, exerts its fungicidal activity at the surface as the result of the contact with the fungus or its spores. Therefore, such nonsystemic fungicides are also frequently referred to as contact-acting fungicides in the literature.

Within the scope of the invention, the term systemic fungicide stands for a fungicidally active compound which, after it has been taken up into the plant, typically via leaves or roots, is translocated within the plant via the transport system. As a rule, systemic organic fungicides are readily soluble in water.

Within the scope of the invention, the term locally-systemic fungicide represents a fungicidally active compound which is taken up into the plant, but is not, or only to a minor degree, translocated within the plant via the transport system.

Within the scope of the invention, the term translaminarly-wetting fungicide stands for a fungicidally active compound which is taken up into the waxy layer of leaves, where it forms a depot and from where it can slowly penetrate into the plant.

It should be mentioned at this point that the scope of the invention extends to any possible combination of the components, range of values or methodological parameters mentioned hereinabove and hereinbelow, either in general or in preferred ranges.

Examples of suitable fungicides are:
aldimorph, ampropylfos, ampropylfos-potassium, andoprim, anilazin, azaconazole, azoxystrobin,
benalaxyl, benodanil, benomyl, benzamacril, bezamacryl-isobutyl, bialaphos, binapacryl, biphenyl, bitertanol, blasticidin-S, bromuconazole, bupirimate, buthiobate,
calcium polysulfide, capsimycin, captafol, captan, carbendazim, carboxin, carvon, quinomethionate, chlobenthiazone, chlorfenazole, chloroneb, chloropicrin, chlorothalonil, chlozolinate, clozylacon, cufraneb, cymoxanil, cyproconazole, cyprodinil, cyprofuram,
debacarb, dichlorophen, diclobutrazol, diclofluanid, diclomezin, dicloran, diethofencarb, difenoconazole, dimethirimol, dimethomorph, diniconazole, diniconazole-M, dinocap, diphenylamine, dipyrithione, ditalimfos, dithianon, dodemorph, dodine, drazoxolon,
ediphenphos, epoxiconazole, etaconazole, ethirimol, etridiazole,
famoxadon, fenapanil, fenarimol, fenbuconazole, fenfuram, fenitropan, fenpiclonil, fenpropidin, fenpropimorph, fentin acetate, fentin hydroxide, ferbam, ferimzone, fluazinam, flumetover, fluoromid, fluquinconazole, flurprimidol, flusilazole, flusulfamide, flutolanil, flutriafol, folpet, fosetyl-aluminum, fosetyl-sodium, fthalide, fuberidazole, furalaxyl, furametpyr, furcarbonil, furconazole, furconazole-cis, furmecyclox,
guazatine,
hexachlorobenzene, hexaconazole, hymexazol,
imazalil, imibenconazole, iminoctadine, iminoctadine albesilate, iminoctadine triacetate, iodocarb, ipconazole, iprobenfos (IBP), iprodione, irumamycin, isoprothiolane, isovaledione,
kasugamycin, kresoxim-methyl, copper preparations such as: copper hydroxide, copper naphthenate, copper octanoate, copper oxychloride, copper sulfate, copper oxide, oxine-copper and Bordeaux mixture,
mancopper, mancozeb, maneb, meferimzone, mepanipyrim, mepronil, metalaxyl, metconazole, methasulfocarb, methfuroxam, metiram, metomeclam, metsulfovax, mildiomycin, myclobutanil, myclozolin,
nickel dimethyldithiocarbamate, nitrothal-isopropyl, nuarimol,
ofurace, oxadixyl, oxamocarb, oxolinic acid, oxycarboxim, oxyfenthiin,
paclobutrazole, pefurazoate, penconazole, pencycuron, phosdiphen, pimaricin, piperalin, polyoxin, polyoxorim, probenazole, prochloraz, procymidone, propamocarb, propanosine-sodium, propiconazole, propineb, pyrazophos, pyrifenox, pyrimethanil, pyroquilon, pyroxyfur,
quinconazole, quintozen (PCNB),
sulfur and sulfur preparations,
tebuconazole, tecloftalam, tecnazen, tetcyclacis, tetraconazole, thiabendazole, thicyofen, thifluzamide, thiophanate-methyl, thiram, tioxymid, tolclofos-methyl, tolylfluanid, triadimefon, triadimenol, triazbutil, triazoxide, trichlamide, tricyclazole, tridemorph, triflumizole, triforine, triticonazole,
uniconazole,
validamycin A, vinclozolin, viniconazole,
zarilamid, zineb, ziram and
Dagger G,
OK-8705,
OK-8801,
α-(1,1-dimethylethyl)-β-(2-phenoxyethyl)-1H-1,2,4-triazole-1-ethanol,
α-(2,4-dichlorophenyl)-β-fluoro-b-propyl-1H-1,2,4-triazole-1-ethanol,
α-(2,4-dichlorophenyl)-β-methoxy-a-methyl-1H-1,2,4-triazole-1-ethanol,
α-(5-methyl-1,3-dioxan-5-yl)-β-[[4-(trifluoromethyl)phenyl]methylene]-1H-1,2,4-triazole-1-ethanol,
(5RS,6RS)-6-hydroxy-2,2,7,7-tetramethyl-5-(1H-1,2,4-triazol-1-yl)-3-octanone,
(E)-a-(methoxyimino)-N-methyl-2-phenoxyphenylacetamide,
1-isopropyl {2-methyl-1-[[[1-(4-methylphenyl)ethyl]amino]carbonyl]propyl}carbamate
1-(2,4-dichlorophenyl)-2-(1H-1,2,4-triazol-1-yl)ethanone-O-(phenylmethyl)oxime,
1-(2-methyl-1-naphthalenyl)-1H-pyrrole-2,5-dione,
1-(3,5-dichlorophenyl)-3-(2-propenyl)-2,5-pyrrolidinedione,
1-[(diiodomethyl)sulfonyl]-4-methylbenzene,
1-[[2-(2,4-dichlorophenyl)-1,3-dioxolan-2-yl]methyl]-1H-imidazole,
1-[[2-(4-chlorophenyl)-3-phenyloxiranyl]methyl]-1H-1,2,4-triazole,
1-[1-[2-[(2,4-dichlorophenyl)methoxy]phenyl]ethenyl]-1H-imidazole,
1-methyl-5-nonyl-2-(phenylmethyl)-3-pyrrolidinol,
2′,6′-dibromo-2-methyl-4′-trifluoromethoxy-4′-trifluoromethyl-1,3-thiazole-5-carboxanilide,
2,2-dichloro-N-[1-(4-chlorophenyl)ethyl]-1-ethyl-3-methylcyclopropanecarboxamide,
2,6-dichloro-5-(methylthio)-4-pyrimidinylthiocyanate,
2,6-dichloro-N-(4-trifluoromethylbenzyl)benzamide,
2,6-dichloro-N-[[4-(trifluoromethyl)phenyl]methyl]benzamide,
2-(2,3,3-triiodo-2-propenyl)-2H-tetrazole,
2-[(1-methylethyl)sulfonyl]-5-(trichloromethyl)-1,3,4-thiadiazole,
2-[[6-deoxy-4-O-(4-O-methyl-β-D-glycopyranosyl)-a-D-gluco-pyranosyl]amino]-4-methoxy-1H-pyrrolo[2,3-d]pyrimidine-5-carbonitrile,
2-aminobutane,
2-bromo-2-(bromomethyl)pentanonitrile,
2-chloro-N-(2,3-dihydro-1,1,3-trimethyl-1H-inden-4-yl)-3-pyridinecarboxamide,
2-chloro-N-(2,6-dimethylphenyl)-N-(isothiocyanatomethyl)acetamide,
2-phenylphenol(OPP),
3,4-dichloro-1-[4-(difluoromethoxy)phenyl]-1H-pyrrole-2,5-dione,
3,5-dichloro-N-[cyano[(1-methyl-2-propynyl)oxy]methyl]benzamide,
3-(1,1-dimethylpropyl-1-oxo)-1H-indene-2-carbonitrile,
3-[2-(4-chlorophenyl)-5-ethoxy-3-isoxazolidinyl]pyridine,
4-chloro-2-cyano-N,N-dimethyl-5-(4-methylphenyl)-1H-imidazole-1-sulfonamide,
4-methyltetrazolo[1,5-a]quinazolin-5(4H)-one,
8-(1,1-dimethylethyl)-N-ethyl-N-propyl-1,4-dioxaspiro[4.5]decane-2-methanamine,
8-hydroxyquinoline sulfate,
9H-xanthene-9-carboxylic 2-[(phenylamino)carbonyl]hydrazide,
bis(1-methylethyl)-3-methyl-4-[(3-methylbenzoyl)oxy]-2,5-thiophene dicarboxylate
cis-1-(4-chlorophenyl)-2-(1H-1,2,4-triazol-1-yl)cycloheptanol,
cis-4-[3-4-(1,1-dimethylpropyl)phenyl-2-methylpropyl]-2,6-dimethylmorpholine hydrochloride,
ethyl [(4-chlorophenyl)azo]cyanoacetate,
methanetetrathiol sodium salt,
methyl 1-(2,3-dihydro-2,2-dimethyl-1H-inden-1-yl)-1H-imidazole-5-carboxylate,
methyl N-(2,6-dimethylphenyl)-N-(5-isoxazolylcarbonyl)-DL-alaninate,
methyl N-(chloroacetyl)-N-(2,6-dimethylphenyl)-DL-alaninate,
N-(2,3-dichloro-4-hydroxyphenyl)-1-methylcyclohexanecarboxamide,
N-(2,6-dimethylphenyl)-2-methoxy-N-(tetrahydro-2-oxo-3-furanyl)acetamide,
N-(2,6-dimethylphenyl)-2-methoxy-N-(tetrahydro-2-oxo-3-thienyl)acetamide,
N-(2-chloro-4-nitrophenyl)-4-methyl-3-nitrobenzenesulfonamide,
N-(4-cyclohexylphenyl)-1,4,5,6-tetrahydro-2-pyrimidinamine,
N-(4-hexylphenyl)-1,4,5,6-tetrahydro-2-pyrimidinamine,
N-(5-chloro-2-methylphenyl)-2-methoxy-N-(2-oxo-3-oxazolidinyl)acetamide,
N-(6-methoxy)-3-pyridinyl)cyclopropanecarboxamide,
N-[2,2,2-trichloro-1-[(chloroacetyl)amino]ethyl]benzamide,
N-[3-chloro-4,5-bis(2-propinyloxy)phenyl]-N′-methoxymethaneimidamide,
N-formyl-N-hydroxy-DL-alanine sodium salt,
O,O-diethyl [2-(dipropylamino)-2-oxoethyl]ethylphosphoramidothioate,
O-methyl S-phenyl phenylpropylphosphoramidothioate,
S-methyl-1,2,3-benzothiadiazole-7-carbothioate and
spiro[2H]-1-benzopyran-2,1′(3′H)-isobenzofuran]-3′-one.

Preferably, the compositions according to the invention comprise one, two or three fungicides which, in an even further preferred embodiment, are selected among those mentioned above. The compositions according to the invention especially preferably comprise one or two fungicides which, in an even further preferred embodiment, are selected among those mentioned above.

In a further specially preferred embodiment of the invention, the compositions according to the invention comprise one or two organic fungicides which are selected among those mentioned above.

In the event that two or more fungicides are used, it is preferred to select at least one nonsystemic or one translaminarly-wetting fungicide and at least one locally-systemic or systemic fungicide.

Very especially preferred compositions according to the invention comprise fluquinconazole and pyrimethanil as fungicides.

The compositions according to the invention can comprise an amount of from 0.001 to 90% by weight of fungicides, preferably from 0.1 to 40% by weight.

Within the scope of the invention, the term formate comprises not only inorganic but also organic formates, and formic acid itself.

In a preferred embodiment, the composition according to the invention comprises formate in the form of potassium formate, sodium formate or calcium formate, or formic acid. This also comprises potassium diformate, sodium diformate, double salts of potassium formate or sodium formate with formic acid.

In a specially preferred embodiment, the composition according to the invention comprises calcium formate.

In a further preferred embodiment, the molar ratio of formates to fungicides is between 0.1:1 and 5000:1, preferably between greater than 1:1 and 1000:1, especially preferably between 5:1 and 500:1 and very especially preferably between 10:1 and 250:1.

The compositions according to the invention furthermore comprise acidic substances. Substances which, as a one-molar solution in water or calculated as a one-molar solution in water or an aqueous comparative scale have a pH of 5.0 or less under standard conditions comprise, for example, those substances which
due to their good solubility in water can be measured as a one-molar solution in water and which have a pH of 5.0 or less under standard conditions
owing to a solubility in water which amounts to less than one mole/l under standard conditions, must be measured as dilute aqueous solutions but which, calculated as a one-molar solution in water, would have a pH of 5.0 or less under standard conditions
due to poor solubility in water or no solubility in water must be measured in a solvent other than water but which, calculated as an aqueous comparative scale, would have a pH of 5.0 or less under standard conditions.

Suitable calculations and tables are well known, not only to those skilled in the art.

Some fungicides are acidic substances within the meaning of the invention. In this case, the presence of at least one additional acidic substance is not required, but preferred.

Formic acid and alkali metal diformates are likewise acidic substances. In this case, the presence of at least one additional acidic substance is likewise not required, but preferred.

Suitable acidic substances are acids and acidic salts. Especially suitable are organic acids with a pKₐ value of from 2.0 to 5.0 and ammonium salts with a correspondingly acidic action such as, for example, ammonium chloride and organic ammonium salts or adducts such as, for example, alkali metal diformates.

If calcium formate is a component of compositions according to the invention, then preferred acids and acidic salts are those which do not form any sparingly-soluble precipitate with calcium ions.

For the purposes of the invention, sparingly-soluble calcium salts are understood as meaning those which have a solubility of less than 1 g/l, in the presence of the corresponding free acid and at pH values of from 3.0 to 6.5 under standard conditions. Examples of suitable organic acids are formic acid, acetic acid, propionic acid, lactic acid, tartaric acid, mallic acid, succinic acid and citric acid, with citric acid being especially preferred.

In a further preferred embodiment, the ratio of fungicides, formates and acidic substances is chosen such that a solution, suspension, slurry or emulsion of one % by weight of the compositions according to the invention in water has a pH of from 4.0 to 6.5, preferably from 4.0 to 5.0 and especially preferably from 4.0 to 4.8 under standard conditions.

The compositions according to the invention can furthermore comprise various additives. For the additives mentioned hereinbelow, it is, in each case independently of one another, also possible not to be present. Examples of possible additives are:
Hygroscopic substances and/or humectants for regulating the moisture: hygroscopic substances are, for example, hygroscopic inorganic salts such as, for example, calcium chloride or calcium nitrate; suitable humectants are, for example, organic substances such as, for example, glycerol, polydextrose, sorbitol, xylitol, propylene glycols, polyethylene glycols or mixtures of these polyols.

In this context, the compositions according to the invention may comprise for example from 0.01 to 40, preferably from 0.2 to 20 and especially preferably from 0.5 to 2% by weight of hygroscopic substances and/or humectants.
Interface-active substances such as, for example, surfactants. Surfactants may be, for example, nonionic, cationic and amphoteric surfactants, preferably anionic. Suitable anionic surfactants are, for example, alkyl sulfates, alkyl ether sulfates, alkylarylsulfonates, alkyl succinates, alkyl sulfosuccinates, N-alkoylsarcosinates, acyl taurates, acyl isethionates, alkyl phosphates, alkyl ether phosphates, alkyl ether carboxylates, alpha-olefin sulfonates, in particular the alkali and alkaline-earth metal salts, for example sodium, potassium, magnesium, calcium, and ammonium and triethanolamine salts. The alkyl ether sulfates, alkyl ether phosphates and alkyl ether carboxylates can in each case have, for example, between 1 and 10 ethylene oxide or propylene oxide units, preferably 1 to 3 ethylene oxide units. Examples of substances which are suitable are sodium lauryl sulfate, ammonium lauryl sulfate, sodium lauryl ether sulfate, ammonium lauryl ether sulfate, sodium lauryl sarcosinate, sodium oleyl succinate, ammonium lauryl sulfosuccinate, sodium dodecylbenzenesulfonate, triethanolamine dodecylbenzenesulfonate. In this context, the compositions according to the invention may comprise, for example, from 0.01 to 10, preferably from 0.2 to 8, especially preferably from 0.3 to 5 and very especially preferably from 0.5 to 3% by weight of interface-active substances.
Wetting agents, such as, for example, alkali metal, alkaline-earth metal, ammonium salts of aromatic sulfonic acids, for example lignosulfonic acid, phenolsulfonic acid, naphthalenesulfonic acid and dibutylnaphthalenesulfonic acid, and of fatty acids, of alkyl- and alkylarylsulfonates, of alkyl sulfates, lauryl ether sulfates and fatty alcohol sulfates, and the salts of sulfated hexa-, hepta- and octadecanols or of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ethers, ethoxylated isooctyl-, octyl- or nonylphenol, alkylphenol or tributylphenyl polyglycol ether, alkylaryl polyether alcohols, isotridecyl alcohol, fatty alcohol/ethylene oxide condensates, ethoxylated castor oil, polyoxyethylene alkyl ethers or polyoxypropylene, lauryl alcohol polyglycol ether acetate, sorbitol esters, lignin-sulfite waste liquors or methylcellulose. In this context, the compositions according to the invention may comprise, for example, from 0.01 to 8, preferably from 0.2 to 6, especially preferably from 0.3 to 5 and very especially preferably from 0.5 to 3% by weight of wetting agents.
Emulsifiers, such as, for example, sodium salts, potassium salts and ammonium salts of straight-chain aliphatic carboxylic acids of chain length C₁₂-C₂₀, sodium hydroxyoctadecanesulfonate, sodium salts, potassium salts and ammonium salts of hydroxy-fatty acids of chain length C₁₂-C₂₀ and their sulfation or acetylation products, alkyl sulfates, also as triethanolamine salts, alkyl-(C₁₀-C₂₀)-sulfonates, alkyl(C₁₀-C₂₀)-arylsulfonates, dimethyldialkyl(C₈-C₁₈)-ammonium chloride, acyl-, alkyl-, oleyl- and alkylaryloxyethylates and their sulfation products, alkali-metal salts of the sulfosuccinic esters with aliphatic saturated monohydric alcohols of chain length C₄-C₁₆, sulfosuccinic acid 4-esters with polyethylene glycol ethers of monohydric aliphatic alcohols of chain length C₁₀-C₁₂ (disodium salt), sulfosuccinic acid 4-esters with polyethylene glycol nonylphenyl ether (disodium salt), sulfosuccinic acid bis-cyclohexyl ester (sodium salt), lignosulfonic acid and its calcium, magnesium, sodium and ammonium salts, polyoxyethylene sorbitan monooleate having 20 ethylene oxide groups, resin acids, hydrogenated and dehydrogenated resin acids and their alkali metal salts, dodecylated sodium diphenyl ether disulfonate, and copolymers of ethylene oxide and propylene oxide with a minimum content of 10% by weight of ethylene oxide. The following are preferably used as emulsifiers: sodium lauryl sulfate, sodium lauryl ether sulfate, ethoxylated (3 ethylene oxide groups); the polyethylene glycol-(4-20) ethers of oleyl alcohol, and the polyethylene oxide-(4-14) ethers of nonylphenol. In this context, the compositions according to the invention may comprise, for example, from 0.01 to 15, preferably from 0.2 to 8, especially preferably from 0.5 to 6 and very especially preferably from 1 to 5% by weight of emulsifiers.
Dispersants such as, for example, alkylphenol polyglycol ethers. In this context, the compositions according to the invention may comprise, for example, from 0.01 to 8, preferably from 0.1 to 6, especially preferably from 0.2 to 5 and very especially preferably from 0.4 to 3% by weight of dispersants.
Stabilizers, such as, for example, cellulose and cellulose derivatives. In this context, the compositions according to the invention may comprise, for example, from 0.01 to 6, preferably from 0.01 to 3, especially preferably from 0.01 to 2 and very especially preferably from 0.01 to 1% by weight of stabilizers.
Stickers, such as carboxymethylcellulose, natural and synthetic polymers in the form of powders, granules or latices, such as gum arabic, polyvinyl alcohol, polyvinyl acetate, and natural phospholipids, such as cephalins and lecithins, and synthetic phospholipids, and liquid paraffins. In this context, the compositions according to the invention may comprise, for example, from 0.01 to 8, preferably from 0.1 to 4, especially preferably from 0.2 to 3 and very especially preferably from 0.2 to 2% by weight of stickers.
Spreaders, such as, for example, isopropyl myristate, polyoxyethylene nonylphenyl ether and polyoxyethylene laurylphenyl ether. In this context, the compositions according to the invention may comprise, for example, from 0.01 to 20, preferably from 0.1 to 10, especially preferably from 0.1 to 5 and very especially preferably from 0.1 to 2% by weight of spreaders.
Organic solvents such as, for example, monohydric or polyhydric alcohols, esters, ketones and hydrocarbons. Examples of suitable solvents are paraffins, for example mineral oil fractions, mineral and vegetable oils, butanol or glycol and their ethers and esters, ketones such as acetone, methyl ethyl ketone, methyl isobutyl ketone or cyclohexanone. In this context, the compositions according to the invention may comprise, for example, from 0.01 to 25, preferably from 0.2 to 12, especially preferably from 0.5 to 7 and very especially preferably from 1 to 4% by weight of organic solvents.
Fragrances and colors, such as inorganic pigments, for example iron oxide, titanium oxide, Prussian blue and organic dyestuffs, such as alizarin, azo and metal phthalocyanin dyestuffs and trace nutrients such as salts of iron, manganese, boron, copper, cobalt, molybdenum and zinc. In this context, the compositions according to the invention may comprise, for example, in each case from 0.001 to 4, preferably from 0.01 to 1, especially preferably from 0.01 to 0.8% by weight of fragrances and colors.
Anti-dust agents, such as, for example, polyglycols and polyglycol ethers. In this context, the compositions according to the invention may comprise, for example, in each case from 0.01 to 2, preferably from 0.05 to 1, especially preferably from 0.1 to 0.5% by weight of anti-dust agents.
Buffer substances, buffer systems or pH regulators. In this context, the compositions according to the invention may comprise, for example, in each case from 0.01 to 10, preferably from 0.1 to 5% by weight of buffer substances, buffer systems or pH regulators.

Preferably, the content of the abovementioned additives in the compositions according to the invention amount in total to from 0.01 to 100, preferably from 0.5 to 10 and especially preferably 1 to 5% by weight, based on the total of fungicides, formates and substances with a pK_{A} value of 5.0 or less.

Furthermore, the fungicidal compositions according to the invention may or may not furthermore in each case independently of one another comprise bactericides, insecticides, acaricides and growth regulators. Preferably, the fungicidal mixtures according to the invention do not comprise any additional bactericides, insecticides or acaricides as further constituents.

Of the invention, the compositions according to the invention are present in any formulation. Preferred formulations are capsule suspensions (CS), water-soluble concentrates (SL), suspension concentrates (SC), wettable powders (WP), water-dispersible granules (WG), with water-soluble concentrates (SL), suspension concentrates (SC) and water-dispersible granules (WG) generally being preferred. In principle, preferred formulation types depend essentially on the fungicide components employed and on their physical properties. Since these are known, however, it is current practice for a person skilled in the art to find a preferred formulation type in few experiments.

Formulations according to the invention can be prepared in a manner known per se.

Especially preferred compositions comprise at least one fungicide, formate based on free formic acid and at least one additional acidic substance in weight ratios of from 1:(0.5 to 500):(0.5 to 500), preferably 1:(10 to 100):(5 to 100) and especially preferably 1:(10 to 50):(10 to 50), where compositions which are even further preferred are those in which the weight ratio of formate based on free formic acid and at least one additional acidic substance is from 0.1:1 to 10:1, especially preferably from 1:1 to 8:1. In a further preferred form, formate is incorporated into the compositions according to the invention formate at least in part, preferably exclusively, as calcium formate.

Very especially preferred compositions comprise at least one fungicide, calcium formate based on free formic acid and at least one organic acid which is solid under standard conditions and has a pKₐ value of from 2.0 to 5.0 in weight ratios of from 1:(0.5 to 500):(0.5 to 500), preferably 1:(10 to 100):(5 to 100) and especially preferably 1:(10 to 50):(10 to 50), where compositions which are even further preferred are those in which the weight ratio of formate based on free formic acid and at least one additional acidic substance is from 0.1:1 to 10:1, especially preferably from 1:1 to 8:1. Very especially preferred in this context are compositions in which an organic acid which is solid under standard conditions is citric acid.

A very preferred composition comprises fluquinconazole, pyrimethanil, calcium formate and citric acid. Such compositions can be obtained for example by mixing the product Vision® from BASF SE (comprises 50 g/l fluquinconazole and 200 g/l pyrimethanil) with the product Folanx® from Lanxess Distribution GmbH (comprises 70 to 80% by weight of calcium formate, 14 to 18% by weight of calcium chloride and 1 to 15% by weight of citric acid).

The invention furthermore comprises aqueous fungicidal compositions which can be obtained by diluting the compositions according to the invention with water.

The compositions according to the invention have very good fungicidal and sporocidal properties and are therefore suitable in particular for controlling phytopathogenic fungi including their spores.

Therefore, the invention also comprises a method of controlling phytopathogenic fungi, which is characterized in that the control is carried out using the compositions according to the invention.

Examples of phytopathogenic fungi are Plasmodiophoromycetes, Oomycetes, Chytridiomycetes, Zygomycetes, Ascomycetes, Basidiomycetes and Deuteromycetes.

Examples of phytopathogenic fungi which can be controlled by the compositions according to the invention are:

Alternaria species, Podosphaera species, Sclerotinia species, Physalospora canker, in particular on vegetables and fruit, Botrytis cinerea (gray mold), in particular on strawberries, vegetables, ornamentals and grapevines, Coxynespora melonis, in particular on cucumbers, strawberries; Colletotrichum species, in particular on cucumbers; Diplocarpon rosae, in particular on roses; Elsinoe fawcetti and Diaporthe citri in particular on citrus fruit; Spaerotheca species, in particular on cucumbers, cucurbits, strawberries and roses; Cercospora species, in particular on peanuts, sugar beet, aubergines and date plums; Erysiphe cichoracearum and Sphaerotheca fuliginea, in particular on cucurbits, Leveiillina taurica, in particular on pimento; Mycosphaerella species, in particular on apples and Japanese apricot; Phyllactinia kakicola, Gloesporium species, in particular on apples, Gloesporium kaki, in particular on Japanese apricot; Gymnosporangium yamadae, Leptotthyrdium pomi, Podosphaera leucotricha and Gloedes pomigena, in particular on apples; Cladosporium carpophilum, in particular on pears and Japanese apricot; Phomopsis species, in particular on pears; Phytopora species, in particular on citrus fruit, potatoes, onions; Phytophthora infestans, in particular on potatoes and tomatoes, Erysiphe graminis (powdery mildew), in particular on cereals, Fusarium and Verticillium species on various plants, Glomerella cingulata, in particular on tea; Helminthosporium species, in particular on cereals, Mycosphaerella species, in particular on bananas and peanuts, Plasmopara viticola, in particular on grapevines and grapefruits, Peronospora species, in particular on onions, spinach and chrysanthemums; Phaeoisariopsis vitis and Spaceloma ampelina, in particular on grapefruits; Pseudocercosporella herpotrichoides, in particular on wheat and barley, Pseudoperonospora species, in particular on hops and cucumbers, Puccinia species and Typhula species, in particular on cereals, Pyricularia oryzae, in particular on rice, Rhizoctonia species, in particular on cotton, rice and lawns, Septoria nodorum, in particular on wheat, Uncinula necator, in particular on grapevines, Usilago species, in particular on cereals and sugar cane, and Venturia species (scab), in particular on apples and pears.

It has been found that the activity of the compositions according to the invention is markedly superior in comparison with the simple activity of the fungicides present in them. According to own findings, this can be attributed to the fact that the activity of the fungicides as components in the association of the compositions according to the invention is increased such that the application rate is considerably increased while achieving the same activity in comparison with the use of the fungicides in compositions which are not in accordance with the invention, or that even resistances to fungicides in compositions which are not according to the invention can be overcome by application in the form of the compositions according to the invention. Indeed, both mechanisms can be observed in many cases.

The particular advantage of the compositions according to the invention is therefore that the amounts of in some cases environmentally-toxic fungicides can be considerably reduced while achieving the same activity, and that end users need not change the fungicide in a spray sequence where a risk of resistance exists, in particular in the case of systemic or locally-systemic fungicides, but can apply the same fungicide in the form of compositions according to the invention, for example after treatment with fungicides in compositions which are not according to the invention.

Compositions comprising fluquinconazole, pyrimethanil, calcium formate and citric acid are particularly suitable for controlling Venturiaceae and their conidia, and in particular the species Venturia inaequalis and its conidia. The abovementioned compositions are therefore particularly suitable for use in fruit production.

The method of controlling phytopathogenic fungi using the compositions according to the invention can be carried out in a manner known per se, for example directly by treating plants and plant parts with the composition or by allowing the composition to act on their environment, habitat or store. The application of the compositions according to the invention can be carried out for example by dipping, spraying, vaporizing, atomizing, scattering, painting on and, in the case of propagation material such as in particular in the case of seeds, preferably by coating with one or more layers. In the case of trees, especially when the compositions according to the invention comprise systemic fungicides, the application may also be carried out by stem application.

According to the invention, all plants and plant parts can be treated with the fungicidal compositions according to the invention and with aqueous compositions obtainable therefrom. In the present context, plants are understood as meaning all plants and plant populations, such as, in particular, crop plants and their populations. In this context, crop plants are understood as meaning, for example, plants including transgenic plants and plant varieties capable or not of being protected by Plant Breeders' Rights and which can be obtained by traditional breeding and optimization methods or by biotechnological and recombinant methods or combinations of these methods. Within the context of the invention, the term plant parts comprises all aerial and subterranean parts and organs of the plants such as, for example, leaves, flowers, fruiting bodies, fruits, tubers, needles, rhizomes, seeds, shoots, stems, stalks and roots and harvested material, vegetative and generative propagation material such as, for example, cuttings, tubers, rhizomes, slips and seeds.

By way of example and by preference, the compositions according to the invention are applied at application rates of from 0.1 to 1.5 l, preferably from 0.375 to 0.5 l/ha/mCH (mCH=meters crown height), where the data relate to aqueous compositions with a content of from 0.1 to 2% by weight of fungicidal compositions according to the invention.

Furthermore, it has been found that a positive effect of the formates and of the acidic substances is also achieved when the application is carried out not simultaneously by the application in the form of a composition according to the invention, but even when the treatment of plants and plant parts with the components of the composition according to the invention takes place within 72 hours, preferably within 36 hours, or when the components of the compositions according to the invention are allowed to act on the environment, the habitat or the store of plants and plant parts within 120 hours, preferably within 36 hours.

The invention therefore also relates to a method of controlling phytopathogenic fungi, characterized in that plants and plant parts are treated within 72 hours or the environment, the habitat or store of plants and plant parts is treated within 120 hours with the components I) to III)
I) at least one fungicide
II) formate
III) at least one substance which, as a one-molar solution in water or calculated as a one-molar solution in water or an aqueous comparative scale, has a pH of 5.0 or less under standard conditions.

If the treatment with components I) to III) is not carried out simultaneously, for example by using a composition according to the invention, it is preferred first to use a composition comprising component I) and thereafter a composition comprising components II) and III).

A composition comprising components II) and III) is preferably a composition comprising calcium formate and an organic acid such as, for example, citric acid. A particularly preferred composition comprising components II) and III) is the product Folanx® from Lanxess Distribution GmbH with the abovementioned composition.

The fungicidal compositions according to the invention and aqueous compositions obtainable therefrom are furthermore suitable for the protection of industrial materials against attack and destruction by undesired microorganisms.

For the purposes of the invention, the term industrial materials comprises nonliving materials for use in industry which are intended to be protected from microbial change or destruction. These include glues, sizes, paper and board, textiles, leather, timber, paints and plastic articles, cooling lubricants, heat transfer fluids and other materials capable of being attacked or decomposed by microorganisms. For example, they also include parts of production plants such as cooling water circuits.

The term undesired microorganisms comprises for example bacteria, fungi and algae, preferably fungi such as, in particular, molds, wood-discoloring and wood-destroying fungi (Basidiomycetes).

Examples of particularly undesirable microorganisms are microorganisms from the following genera: Alternaria, such as, for example, Alternaria tenuis, Aspergillus, such as, for example, Aspergillus niger, Chaetomium, such as, for example, Chaetomium globosum, Coniophora, such as, for example, Coniophora puetana, Lentinus, such as, for example, Lentinus tigrinus, Penicillium, such as, for example, Penicillium glaucum, Polyporus, such as, for example, Polyporus versicolor, Aureobasidium, such as, for example, Aureobasidium pullulans, Sclerophoma, such as, for example, Sclerophoma pityophila, Trichoderma, such as, for example, Trichoderma viride, Escherichia, such as, for example, Escherichia coli, Pseudomonas, such as, for example, Pseudomonas aeruginosa, Staphylococcus, such as, for example, Staphylococcus aureus.

The following examples are set forth to further illustrate the invention.

### EXAMPLES

A. Controlling conidia of Venuria inaequalis
1. Conidia:
   Name: Oberdorf 06
   In comparison with the basic sensitivity, these conidia are resistant to anilinopyrimidines and sterol biosynthesis inhibitors.
2. Fungicide:
   Vision® from BASF SE (comprises 200 g/l pyrimethanil, 50 g/l fluquinconazole) Recommended application rate: 0.1%
3. Composition according to the invention:
   Mixture of 1 part by weight of Vision® and 10 parts by weight of Folanx® Ca29 (sample comprises 75% by weight of calcium formate, 10% by weight of citric acid, 13% by weight of calcium chloride)

### Procedure:

1. Inoculation and incubation of the plants at 18° C. in a humid chamber
2. Drying off the plants
3. Curative treatment after 24 h
4. Incubation in the greenhouse until scab lesions become visible

### Results:

The material scored were the three youngest leaves at the point of time of inoculation. The percentage leaf area covered by scab lesions was estimated. The average disease level of the three evaluated leaves was calculated. The 2×6 shoots per treatment were used for calculating a mean disease value based on 12 shoots in the treatment.

The results can be seen in Table 1.

| | | Disease | | Efficacy |
|---|---|---|---|---|
| Example | Treatment | level in % | Statistics | in % |
| A-1 | Control | 22.3 | a | — |
| A-2 | 0.1% Vision | 8.3 | bcd | 63 |
| A-3 | 1% composition according | 0.7 | d | 97 |
| | to the invention | | | |

In this experiment, the fungicide Vision® at its recommended application rate of 0.5 l/ha/mCH (=0.1%) resulted in a significant efficacy of 63%. When employing the composition according to the invention in an amount which corresponds to the recommended application rate of Vision®, the efficacy rises significantly to 97%. Upon comparing the activity of the composition according to the invention against resistant scab strains with the activity of 0.1% Vision® against sensitive scab strains, an almost identical activity results.

B. Controlling conidia of Venturia inaequalis at Reduced Application Rates of Fungicides

Experiment B was carried out analogously to experiment A, but with the following modifications:

### Procedure:

1. Inoculation and incubation of the plants at 18° C. in a humid chamber
2. Drying off the plants
3. Curative treatment after 24 h
4. Incubation in the greenhouse until scab lesions become visible

### Results:

The material scored were the three youngest leaves at the point of time of inoculation. The percentage leaf area covered by scab lesions was estimated. The average disease level of the three evaluated leaves was calculated. The 2×6 shoots per treatment were used for calculating a mean disease value based on 12 shoots in the treatment.

The results can be seen in Table 2.

| | | Disease | | Efficacy in |
|---|---|---|---|---|
| Example | Treatment | level in % | Statistics | % |
| B-1 | Control | 22.3 | a | — |
| B-2 | 0.033% Vision | 14.0 | ab | 37 |
| B-3 | 0.011% Vision | 11.5 | bc | 49 |
| B-4 | 1% Folanx ®Ca29 + | 4.0 | cd | 82 |
| | 0.033% Vision ® | | | |
| B-5 | 1% Folanx ®Ca29 + | 6.3 | bcd | 72 |
| | 0.011% Vision ® | | | |

Conclusion: The addition of 5 kg/hg Folanx®Ca29 (1%) also increases the activity of the reduced application rates of Vision®.

What is claimed is:

1. A fungicidal composition, comprising, as components,
at least one fungicide
formate
at least one substance which, as a one-molar solution in water or calculated as a one-molar solution in water or an aqueous comparative scale has a pH of 5.0 or less under standard conditions.

2. A fungicidal composition as claimed in claim 1, characterized in that the fungicides are selected from the group of the systemic, locally-systemic or translaminarly-wetting organic fungicides or the nonsystemic fungicides.

3. The fungicidal composition as claimed in claim 1 or 2, characterized in that one or more of the following are employed as fungicides:
aldimorph, ampropylfos, ampropylfos-potassium, andoprim, anilazin, azaconazole, azoxystrobin,
benalaxyl, benodanil, benomyl, benzamacril, bezamacryl-isobutyl, bialaphos, binapacryl, biphenyl, bitertanol, blasticidin-S, bromuconazole, bupirimate, buthiobate,
calcium polysulfide, capsimycin, captafol, captan, carbendazim, carboxin, carvon, quinomethionate, chlobenthiazone, chlorfenazole, chloroneb, chloropicrin, chlorothalonil, chlozolinate, clozylacon, cufraneb, cymoxanil, cyproconazole, cyprodinil, cyprofuram,
debacarb, dichlorophen, diclobutrazol, diclofluanid, diclomezin, dicloran, diethofencarb, difenoconazole, dimethirimol, dimethomorph, diniconazole, diniconazole-M, dinocap, diphenylamine, dipyrithione, ditalimfos, dithianon, dodemorph, dodine, drazoxolon,
ediphenphos, epoxiconazole, etaconazole, ethirimol, etridiazole,
famoxadon, fenapanil, fenarimol, fenbuconazole, fenfuram, fenitropan, fenpiclonil, fenpropidin, fenpropimorph, fentin acetate, fentin hydroxide, ferbam, ferimzone, fluazinam, flumetover, fluoromid, fluquinconazole, flurprimidol, flusilazole, flusulfamide, flutolanil, flutriafol, folpet, fosetyl-aluminum, fosetyl-sodium, fthalide, fuberidazole, furalaxyl, furametpyr, furcarbonil, furconazole, furconazole-cis, furmecyclox,
guazatine,
hexachlorobenzene, hexaconazole, hymexazol,
imazalil, imibenconazole, iminoctadine, iminoctadine albesilate, iminoctadine triacetate, iodocarb, ipconazole, iprobenfos (IBP), iprodione, irumamycin, isoprothiolane, isovaledione,
kasugamycin, kresoxim-methyl, copper preparations such as: copper hydroxide, copper naphthenate, copper octanoate, copper oxychloride, copper sulfate, copper oxide, oxine-copper and Bordeaux mixture,
mancopper, mancozeb, maneb, meferimzone, mepanipyrim, mepronil, metalaxyl, metconazole, methasulfocarb, methfuroxam, metiram, metomeclam, metsulfovax, mildiomycin, myclobutanil, myclozolin,
nickel dimethyldithiocarbamate, nitrothal-isopropyl, nuarimol,
ofurace, oxadixyl, oxamocarb, oxolinic acid, oxycarboxim, oxyfenthiin,
paclobutrazole, pefurazoate, penconazole, pencycuron, phosdiphen, pimaricin, piperalin, polyoxin, polyoxorim, probenazole, prochloraz, procymidone, propamocarb, propanosine-sodium, propiconazole, propineb, pyrazophos, pyrifenox, pyrimethanil, pyroquilon, pyroxyfur,
quinconazole, quintozen (PCNB),
sulfur and sulfur preparations,
tebuconazole, tecloftalam, tecnazen, tetcyclacis, tetraconazole, thiabendazole, thicyofen, thifluzamide, thiophanate-methyl, thiram, tioxymid, tolclofos-methyl, tolylfluanid, triadimefon, triadimenol, triazbutil, triazoxide, trichlamide, tricyclazole, tridemorph, triflumizole, triforine, triticonazole,
uniconazole,
validamycin A, vinclozolin, viniconazole,
zarilamid, zineb, ziram and
Dagger G,
OK-8705,
OK-8801,
α-(1,1-dimethylethyl)-β-(2-phenoxyethyl)-1H-1,2,4-triazole-1-ethanol,
α-(2,4-dichlorophenyl)-β-fluoro-b-propyl-1H-1,2,4-triazole-1-ethanol,
α-(2,4-dichlorophenyl)-β-methoxy-a-methyl-1H-1,2,4-triazole-1-ethanol,
α-(5-methyl-1,3-dioxan-5-yl)-β-[[4-(trifluoromethyl)phenyl]methylene]-1H-1,2,4-triazole-1-ethanol,
(5RS,6RS)-6-hydroxy-2,2,7,7-tetramethyl-5-(1H-1,2,4-triazol-1-yl)-3-octanone,
(E)-a-(methoxyimino)-N-methyl-2-phenoxyphenylacetamide,
1-isopropyl {2-methyl-1-[[[1-(4-methylphenyl)ethyl]amino]carbonyl]propyl}carbamate
1-(2,4-dichlorophenyl)-2-(1H-1,2,4-triazol-1-yl)ethanone-O-(phenylmethyl)oxime,
1-(2-methyl-1-naphthalenyl)-1H-pyrrole-2,5-dione,
1-(3,5-dichlorophenyl)-3-(2-propenyl)-2,5-pyrrolidinedione,
1-[(diiodomethyl)sulfonyl]-4-methylbenzene,
1-[[2-(2,4-dichlorophenyl)-1,3-dioxolan-2-yl]methyl]-1H-imidazole,
1-[[2-(4-chlorophenyl)-3-phenyloxiranyl]methyl]-1H-1,2,4-triazole,
1-[1-[2-[(2,4-dichlorophenyl)methoxy]phenyl]ethenyl]-1H-imidazole,
1-methyl-5-nonyl-2-(phenylmethyl)-3-pyrrolidinol,
2′,6′-dibromo-2-methyl-4′-trifluoromethoxy-4′-trifluoromethyl-1,3-thiazole-5-carboxanilide,
2,2-dichloro-N-[1-(4-chlorophenyl)ethyl]-1-ethyl-3-methylcyclopropanecarboxamide,
2,6-dichloro-5-(methylthio)-4-pyrimidinylthiocyanate,
2,6-dichloro-N-(4-trifluoromethylbenzyl)benzamide,
2,6-dichloro-N[[4-(trifluoromethyl)phenyl]methyl]benzamide,
2-(2,3,3-triiodo-2-propenyl)-2H-tetrazole,
2-[(1-methylethyl)sulfonyl]-5-(trichloromethyl)-1,3,4-thiadiazole,
2-[[6-deoxy-4-O-(4-O-methyl-β-D-glycopyranosyl)-a-D-glucopyranosyl]amino]-4-methoxy-1H-pyrrolo[2,3-d]pyrimidine-5-carbonitrile,
2-aminobutane,
2-bromo-2-(bromomethyl)pentanonitrile,
2-chloro-N-(2,3-dihydro-1,1,3-trimethyl-1H-inden-4-yl)-3-pyridinecarboxamide,
2-chloro-N-(2,6-dimethylphenyl)-N-(isothiocyanatomethyl)acetamide,
2-phenylphenol(OPP),
3,4-dichloro-1-[4-(difluoromethoxy)phenyl]-1H-pyrrole-2,5-dione,
3,5-dichloro-N-[cyano[(1-methyl-2-propynyl)oxy]methyl]benzamide,
3-(1,1-dimethylpropyl-1-oxo)-1H-indene-2-carbonitrile,
3[2-(4-chlorophenyl)-5-ethoxy-3-isoxazolidinyl]pyridine,
4-chloro-2-cyano-N,N-dimethyl-5-(4-methylphenyl)-1H-imidazole-1-sulfonamide,
4-methyltetrazolo[1,5-a]quinazolin-5(4H)-one,
8-(1,1-dimethylethyl)-N-ethyl-N-propyl-1,4-dioxaspiro[4.5]decane-2-methanamine,
8-hydroxyquinoline sulfate,
9H-xanthene-9-carboxylic 2-[(phenylamino)carbonyl]hydrazide,
bis(1-methylethyl)-3-methyl-4-[(3-methylbenzoyl)oxy]-2,5-thiophene dicarboxylate
cis-1-(4-chlorophenyl)-2-(1H-1,2,4-triazol-1-yl)cycloheptanol,
cis-4-[3-[4-(1,1-dimethylpropyl)phenyl-2-methylpropyl]-2,6-dimethylmorpholine hydrochloride,
ethyl [(4-chlorophenyl)azo]cyanoacetate,
methanetetrathiol sodium salt,
methyl 1-(2,3-dihydro-2,2-dimethyl-1H-inden-1-yl)-1H-imidazole-5-carboxylate,
methyl N-(2,6-dimethylphenyl)-N-(5-isoxazolylcarbonyl)-DL-alaninate,
methyl N-(chloroacetyl)-N-(2,6-dimethylphenyl)-DL-alaninate,
N-(2,3-dichloro-4-hydroxyphenyl)-1-methylcyclohexanecarboxamide,
N-(2,6-dimethylphenyl)-2-methoxy-N-(tetrahydro-2-oxo-3-furanyl)acetamide,
N-(2,6-dimethylphenyl)-2-methoxy-N-(tetrahydro-2-oxo-3-thienyl)acetamide,
N-(2-chloro-4-nitrophenyl)-4-methyl-3-nitrobenzenesulfonamide,
N-(4-cyclohexylphenyl)-1,4,5,6-tetrahydro-2-pyrimidinamine,
N-(4-hexylphenyl)-1,4,5,6-tetrahydro-2-pyrimidinamine,
N-(5-chloro-2-methylphenyl)-2-methoxy-N-(2-oxo-3-oxazolidinyl)acetamide,
N-(6-methoxy)-3-pyridinyl)cyclopropanecarboxamide,
N-[2,2,2-trichloro-1-[(chloroacetyl)amino]ethyl]benzamide,
N-[3-chloro-4,5-bis(2-propinyloxy)phenyl]-N′-methoxymethaneimidamide,
N-formyl-N-hydroxy-DL-alanine sodium salt,
O,O-diethyl [2-(dipropylamino)-2-oxoethyl]ethylphosphoramidothioate,
O-methyl S-phenyl phenylpropylphosphoramidothioate,
S-methyl-1,2,3-benzothiadiazole-7-carbothioate and
spiro[2H]-1-benzopyran-2,1′(3′H)-isobenzofuran]-3′-one.

4. A fungicidal composition as claimed in any of claims 1 to 3, characterized in that two or three fungicides are present as components.

5. A fungicidal composition as claimed in any of claims 1 to 4, characterized in that they comprise fluquinconazole and pyrimethanil.

6. A fungicidal composition as claimed in any of claims 1 to 5, characterized in that it comprises an amount of from 0.001 to 90% by weight of fungicides.

7. A fungicidal composition as claimed in any of claims 1 to 6, characterized in that it comprises formate in the form of potassium formate, sodium formate or calcium formate, or formic acid.

8. A fungicidal composition as claimed in claim 7, characterized in that it comprises calcium formate.

9. A fungicidal composition as claimed in any of claims 1 to 8, characterized in that the molar ratio of formates to fungicides is between 5:1 and 500:1.

10. A fungicidal composition as claimed in any of claims 1 to 9, characterized in that the substances which are employed as a one-molar solution in water or calculated as a one-molar solution in water or an aqueous comparative scale have a pH of 5.0 or less under standard conditions are those from the group consisting of formic acid, acetic acid, propionic acid, lactic acid, tartaric acid, manic acid, succinic acid and citric acid.

11. A fungicidal composition as claimed in any of claims 1 to 10, characterized in that the weight ratio of fungicides, formate based on free formic acid and substances which are employed as a one-molar solution in water or calculated as a one-molar solution in water or an aqueous comparative scale have a pH of 5.0 or less under standard conditions is from 1:(10 to 100):(5 to 100).

12. An aqueous composition, obtainable by diluting fungicidal compositions as claimed in any of claims 1 to 11 with water.

13. A method of controlling phytopathogenic fungi, characterized in that the control is carried out using fungicidal compositions as claimed in any of claims 1 to 11 or aqueous compositions as claimed in claim 12.

14. A method of controlling phytopathogenic fungi, characterized in that plants and plant parts are treated within 72 hours or the environment, the habitat or store of plants and plant parts is treated within 120 hours with the components I) to III)
I) at least one fungicide
II) formate
III) at least one substance which, as a one-molar solution in water or calculated as a one-molar solution in water or an aqueous comparative scale, has a pH of 5.0 or less under standard conditions.

15. The use of fungicidal compositions as claimed in any of claims 1 to 11 or aqueous compositions as claimed in claim 12 for controlling phytopathogenic fungi.

16. The use of fungicidal compositions as claimed in any of claims 1 to 11 or aqueous compositions as claimed in claim 12 for protecting technical materials against attack and destruction by undesired microorganisms.
